(19) United States
(12) Patent Application Publication
(10) Pub. No.: US 2022/0147144 A1
(43) Pub. Date: May 12, 2022

(54) SYSTEMS AND METHODS FOR HUMAN-MACHINE INTEGRATION

(71) Applicant: Case Western Reserve University, Cleveland, OH (US)

(72) Inventor: Dustin J. TYLER, Cleveland, OH (US)

(21) Appl. No.: 17/437,906

(22) PCT Filed: Mar. 18, 2020
(86) PCT No.: PCT/US2020/023334

§ 371 Date: Sep. 10, 2021

Related U.S. Application Data
(60) Provisional application No. 62/819,698, filed on Mar. 18, 2019.

(51) Int. Cl. G06F 3/01; G05B 15/02

(52) U.S. Cl. CPC G06F 3/015; G05B 15/02

(57) ABSTRACT

Systems and methods for human-machine integration to facilitate Human Fusions by providing reliable endpoint-to-endpoint connection and communication between humans and devices are described. A controller that includes a processor can receive physiological data related to movement from a user; translate the physiological data related to movement to a transmissible signal to be sent across a network; and send, by the controller, the transmissible signal across the network to at least one device connected to the network. The at least one device can translate at least a portion of the transmissible signal to a form usable by a component of the at least one device to perform an action based on the physiological data related to movement. In some instances, the device can provide feedback to the controller for transmission to the user.

### RELATED APPLICATIONS

This application claims priority to U.S. Provisional Application Ser. No. 62/819,698, filed Mar. 18, 2019, entitled “SOW ON HUMAN FUSIONS WITH UTL/CDL TO NEURAL INTERFACES.” The entirety of this provisional application is hereby incorporated by reference for all purposes.

### TECHNICAL FIELD

The present disclosure relates generally to human-machine networked (Human) functional symbiotic integration on neural systems (Fusions) and, more specifically, to systems and methods for human-machine integration to facilitate Human Fusions by providing reliable endpoint-to-endpoint connection and communication between humans and devices.

### BACKGROUND

Recently, a prosthetic device has been developed that can provide long-term reliable sensory input to a user while simultaneously collecting command information directly from the user's nerves and muscles, providing a direct connection between the user and the prosthetic device. In fact, the direct connection can be established without prosthetic device even touching the user. As long as the prosthetic device can receive inputs from the user, the prosthetic device can be anywhere in the world. This physical separation between the human and prosthetic device gave rise to a dream of human-machine networked (Human) functional symbiotic integration on neural systems (Fusions) with a goal of connecting the human brain, technology, and society through neural interfaces, thereby enabling the human mind to transcend the barriers of the body. In other words, Human Fusions can theoretically allow a person who is physically in one place to perform work or have experiences in another (real or virtual) place. However, Human Fusions requires reliable endpoint-to-endpoint connection and communication between humans and devices, which has yet to be achieved.

### SUMMARY

The present disclosure relates to systems and methods for human-machine integration to facilitate Human Fusions by providing reliable endpoint-to-endpoint connection and communication between humans and devices.

In an aspect, the present disclosure can include a for human-machine integration to facilitate Human Fusions by providing reliable endpoint-to-endpoint connection and communication between humans and devices. The steps of the method can be executed by a controller comprising a processor and include at least: receiving physiological data related to movement from a user; translating the physiological data related to movement to a transmissible signal to be sent across a network; and sending the transmissible signal across the network to at least one device connected to the network. The at least one device translates at least a portion of the transmissible signal to a form usable by a component of the device to perform an action based on the physiological data related to movement.

In another aspect, the present disclosure can include a system that can record and send physiological data related to a user's movement to a device capable of performing an action based on the data received. The system can include at least one electrode configured to record a physiological data related to movement from a nerve and/or a muscle of a user. The system can also include a controller coupled to the electrode and connected to a network comprising a processor. The processor can be configured to receive the physiological data related to movement, translate the physiological data related to movement to a transmissible signal, and send the transmissible signal across the network to at least one device connected to the network. A device can translate at least a portion of the transmissible signal to a form usable by a component of the device to perform an action based on the physiological data related to movement.

### BRIEF DESCRIPTION OF THE DRAWINGS

The foregoing and other features of the present disclosure will become apparent to those skilled in the art to which the present disclosure relates upon reading the following description with reference to the accompanying drawings, in which:

FIG. 1 is a schematic diagram showing an example of a system that can be used to achieve human-machine integration to facilitate Human Fusions by providing reliable endpoint-to-endpoint connection and communication between one or more humans and one or more devices in accordance with an aspect of the present disclosure;

FIG. 2 shows an example of the network of FIG. 1 configured with many users being able to connect and communicate with a device;

FIG. 3 shows an example of the network of FIG. 1 configured with one user being able to connect and communicate with many devices;

FIG. 4 shows an example of the network of FIG. 1 configured with many users being able to connect and communicate with many devices;

FIG. 5 shows an example of the network of FIG. 1 including one or more universal translation layers to facilitate communication between one or more users and one or more devices;

FIG. 6 shows an example of the network of FIG. 1 including functional components of one or more universal translation layers to facilitate communication between one or more users and one or more devices;

FIG. 7 shows an example of the network of FIG. 1 including one or more universal translation layers and additional components to facilitate communication between one or more users and one or more devices; and

FIGS. 8 and 9 are process flow diagrams illustrating example methods for achieving human-machine integration to facilitate Human Fusions by providing reliable endpoint-to-endpoint connection and communication between one or more humans and one or more devices with another aspect of the present disclosure.

### DETAILED DESCRIPTION

### I. Definitions

Unless otherwise defined, all technical terms used herein have the same meaning as commonly understood by one of ordinary skill in the art to which the present disclosure pertains.

As used herein, the singular forms “a,” “an” and “the” can also include the plural forms, unless the context clearly indicates otherwise.

As used herein, the terms “comprises” and/or “comprising,” can specify the presence of stated features, steps, operations, elements, and/or components, but do not preclude the presence or addition of one or more other features, steps, operations, elements, components, and/or groups.

As used herein, the term “and/or” can include any and all combinations of one or more of the associated listed items.

As used herein, the terms “first,” “second,” etc. should not limit the elements being described by these terms. These terms are only used to distinguish one element from another. Thus, a “first” element discussed below could also be termed a “second” element without departing from the teachings of the present disclosure. The sequence of operations (or acts/steps) is not limited to the order presented in the claims or figures unless specifically indicated otherwise.

As used herein, the term “Human Fusions” (or “human-machine networked (Human) functional symbiotic integration on neural systems (Fusions)”) can relate to allowing a user who is in one place to perform work or have experiences in another (real or virtual) place. Human Fusions connects the user's brain to technology and society through human-device interfaces, which enable the user's brain and entire nervous system to transcend the barriers of the user's body. The human-device interfaces can employ an endpoint-to-endpoint (e.g., at least one human-to-at least one device) connection to enable communication (e.g., bidirectional communication) between endpoints. For example, a device can receive a control signal from a user, perform an action based on the control signal, and send a feedback signal to the user based on the action.

As used herein, the terms “user”, “human”, or the like can refer to any organism including, but not limited to, a human being. In the context of human fusions, the user can be a human whose nervous system is integrated with a device through a network.

As used herein, the terms “device”, “machine”, or the like can refer to one or more pieces of mechanical or electronic equipment made or adapted for a particular purpose.

As used herein, the term “component” can refer to additional hardware and/or software that may be a part of/work in connection with a user or a device.

As used herein, the term “network” can refer to a system of connections between endpoints, including users, devices, as well as additional hardware or software components associated with the users and/or devices. For example, the users and devices can be networked together to exchange information therebetween.

As used herein, the term “round-trip” can refer to the process of communication over the network. For example, the communication can include a control signal that can be sent from a user to a device, prompting the device to send a feedback signal to the user in response to the control signal and/or an action performed based on the control signal.

As used herein, the term “symbiotic” can refer to a mutually beneficial interaction or relationship between different users and/or devices (e.g., an interaction that improves the experience or function of all parties involved).

As used herein, the term “integration” can refer to the coordination and/or intermixing of distinct elements (e.g. humans and devices) that were previously not associated.

As used herein, the term “control signal” can refer to information generated based on and/or derived from physiological data related to biological functions that can be measured, recorded and/or analyzed. For example, the physiological data can be related to a physical movement, including include the movements of one or more of a user's limbs, digits, eyes, head, etc. The biological function can include neural signals recorded by one or more recording electrodes, electromyographic (EMG) signals, results of physical movements (e.g., button pushes), and the like.

As used herein, the term “feedback signal” can refer to information generated from a device in response to a control signal (e.g., receipt of a control signal, an action performed based on the control signal, etc.). For example, feedback signals sent from the device may act as a neural input for the user that can be received and processed by the user's nervous system without corruption to the information encoded by the signal. As an example, the feedback signal can be transmitted to the user using one or more stimulating electrodes.

As used herein, the term “endpoint-agnostic” can data transmission across a network that can be received and used by any entity (e.g., one or more users and/or or one or more devices) connected to a particular network. Endpoint-agnostic data transmission may employ one or more additional components that can translate signals to be used by a certain entity.

As used herein, the term “translate,” “translating,” “translation,” and the like can refer to the process of converting one signal into another type of signal, changing the form but not substantially altering the information being communicated by the signal. For example, physiological data generated by a user's movement must be translated into a control signal that can be received and understood by a device. Similarly, a feedback signal from the device must be translated to a form that can be received and understood by a user. A universal translation layer with at least one common data library can be used to facilitate the conversion of signals into different forms.

As used herein, the term “common data library” can refer to information or processes that aid in the translation of signals. For example, the common data library comprising a wide array of algorithms which can be used to translate one signal into one or more possible different formats.

As used herein, the term “electrode” can refer to one or more electrical conductors that contact a portion of a user's body. In some instances, each individual electrical conductor can be referred to as a “contact”.

### II. Overview

Human Fusions refers to a type of human-machine integration that allows users to control remote devices located anywhere in the world while experiencing the sensory feedback of a “direct” connection with the device. Accordingly, Human Fusions can expand the human experience and expertise by enabling human-machine intervention between a user and a remote device that can further applications in a wide range of industries/applications, for example, with human health, humanoid robotics, industrial, military, social, entertainment, gaming, and the like. Unfortunately, Human Fusions has not yet been realized due to the lack of reliable and universal endpoint-to-endpoint connection and communication between humans and devices. The present disclosure enables Human Fusions by providing such reliable and universal endpoint-to-endpoint connection and communication between humans and devices.

The present disclosure relates to systems and methods for human-machine integration to facilitate Human Fusions by providing reliable endpoint-to-endpoint connection and communication between humans and devices. The systems and methods provide an endpoint-agnostic connection between at least one user and at least one remote device. In operation, the at least one remote device can receive a control signal from one or more users (sent across the network described herein) and perform actions based on the control signal. Similarly, the one or more users can receive a feedback signal (e.g., a sensory feedback signal) from the one or more remote devices (sent across the network described herein) related to the actions being performed. Accordingly, the one or more users can control one or more remote devices located anywhere in the world while experiencing the sensory feedback of a “direct” connection with the one or more devices (without actually establishing the direct, tactile connection).

### III. Systems

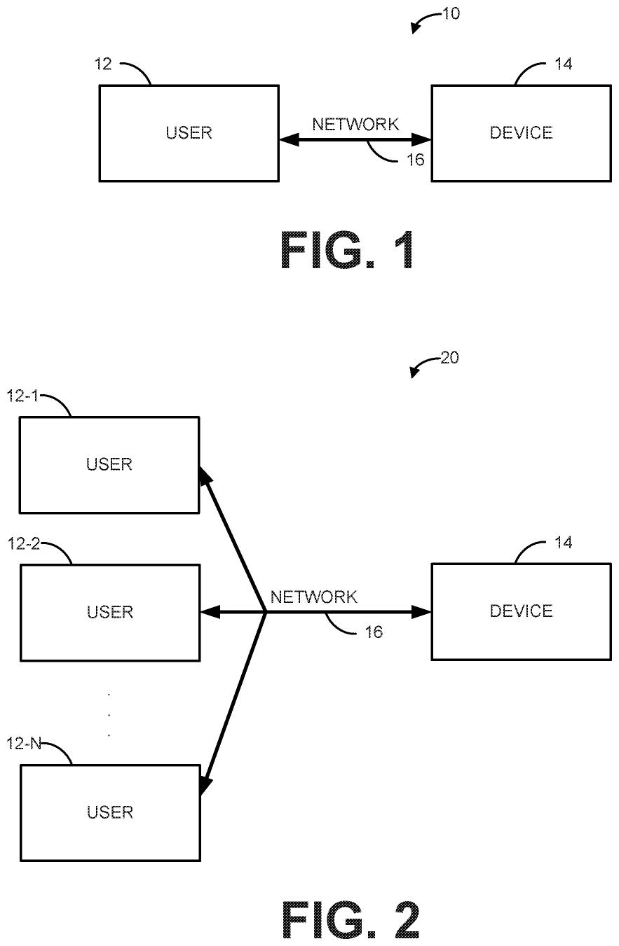

An aspect of the present disclosure can include a system 10 (FIG. 1) that can be used to achieve human-machine integration to facilitate Human Fusions by providing reliable endpoint-to-endpoint connection and communication between one or more humans and one or more devices. At its core, Human Fusions (or human-machine networked functional symbiotic integration on neural systems) allows a user who is in one place to perform work or have experiences in another (real or virtual) place using a device that is located at the other place with sensory feedback from the device through a human-device interface. The human-device interface can employ an endpoint-to-endpoint (e.g., at least one human-to-at least one device) connection to enable communication (e.g., bidirectional communication) between endpoints. For example, a device can receive a control signal from a user, perform an action based on the control signal, and send a feedback signal to the user based on the action.

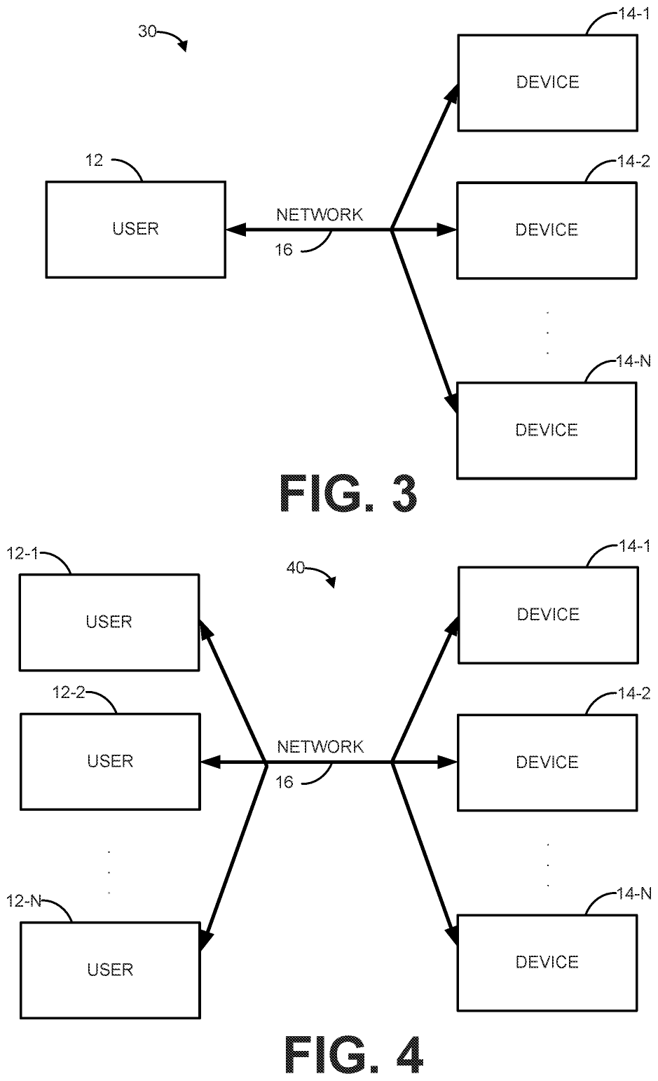

As such, the human-device interface of the system 10 connects one or more users 12 with one or more devices 14 across a network 16 that can facilitate round-trip communication. The human-device interface of the system 10 utilizes a variety of hardware and software components to allow universal connection between user(s) 12 and device(s) 14 so that the user(s) 12 and device(s) 14 each can send outputs and receive inputs across a common network structure that is endpoint-agnostic. It should be noted that the user(s) 12 and device(s) 14 can be referred to as endpoints, nodes, or the like of the network 16. The system 10 can enable arbitrary connections between user nodes and device nodes. While FIG. 1 shows an example of a user 12 to device 14 network configuration across network 16, FIGS. 2-4 show examples of different potential network configurations. An example of a many user 12-1, 12-2, . . . , 12-N to one device 14 network configuration across network 16 is shown in FIG. 2. Another example of a user 12 to many devices 14-1, 14-2, . . . , 14-N network configuration across network 16 is shown in FIG. 3. A further example of a many users 12-1, 12-2, . . . , 12-N to many devices 14-1, 14-2, . . . , 14-N network configuration across network 16 is shown in FIG. 4. Although the terms “user 12” and “device 14” will be used from here forward, it will be understood that “user 12” refers to one or more users and “device 14” refers to one or more devices.

The user 12 can provide physiological data related to movement, which can be sent as a control signal across the network 16 to the device 14. As an example, the user can be a human and the physiological data can be, for example, data (e.g., data associated with a muscle, data associated with a nerve, etc.) recorded by one or more electrodes (e.g., surface electrodes, implanted electrodes, etc.), data gathered by an input device (e.g., a button press, a keystroke, an audio signal, or the like). The control signal can be sent to a component associated with the device 14 (e.g., a controller/microcontroller/processor associated with the device), and the device 14 can perform an action based on the control signal. The same or a different component of the device 14 (e.g., one or more sensors) can send a feedback signal in response to receiving the control signal and/or performing the action. The feedback signal can be transmitted across the network 16 to the user 12, which can receive the feedback signal. For example, the user can receive the feedback signal, which can include sensory feedback, through one or more electrodes. Accordingly, the communication between the user 12 and the device 14 can include a motor output from the user 12 that is transmitted to the device 14 across the network 16 instructing the device 14 to perform an action, while the device 14 can send a feedback signal to the user 12, which can receive a sensory input. Accordingly, the user 12 can control a remote device 14, while receiving sensory feedback related to the control, enabling the user's brain and entire nervous system to transcend the barriers of the user's body and cross the distance separating the user 12 and the device 14. As an example, the user 12 can be equipped with a HAPTIX iSens system that can be connected to the network 16 to provide the physiological signal and receive the feedback signal.

The user 12 and the device 14 are each “endpoints” on the network 16. The user 12 and the device 14 can include additional hardware and software elements, referred to generally as “controllers”, which can include a processor and/or a non-transitory memory, to facilitate connection to the network 16 and/or communication across the network 16. The network 16 between the user 12 and the device 14 is able to support real time experiential, human-in-the-loop systems (e.g., the network must transmit data in a time-critical manner at least because the human sensory system can be sensitive to multi-sensory integration and even millisecond errors in timing between different sources of information or in round-trip control cycles). The network 16 between the user 12 and the device 14 has high reliability, high bandwidth, low latency, and a guaranteed round-trip time, as well as an appropriate management of errant and lost packets.

The connection between the one or more humans and one or more devices can be a universal connection, even though the inputs and outputs may be different from one another. Additionally, the network 16 considers hierarchical input and output distributions, and is robust to faults in data transmission. This can be done, as an example, by having the user 12 and the device 14 negotiate and agree on the specific control information required and then train an algorithm for this specific translation (this act would need to be repeated for different users and/or devices). As another example, this can be done independent of communication between the user 12 and the device 14 with a universal translation layer and common data layer. In this example, when the different common data layers are connected, the different common data layers can negotiate a mapping paradigm between the common data layers that are understood by the nodes. The mapping of the different common data layers can be done automatically by software, requested as setup input from the user 12, and/or adjusted as necessary during the connection. The common data libraries and the translations can enable the universal connection. When more than one user 12 (who may have different data collect/distribution mechanisms) is connected to the network 16, each user 12 can have a unique universal translation layer. Similarly, when more than one device 14 (which may have different data collection/distribution mechanisms) is connected to the network 16, each device 14 can have a unique universal translation layer. As an example, when one user 12 is connected to the network 16, but two different devices 14 are connected to the network 16, the physiological data can be translated to forms acceptable by both devices 14.

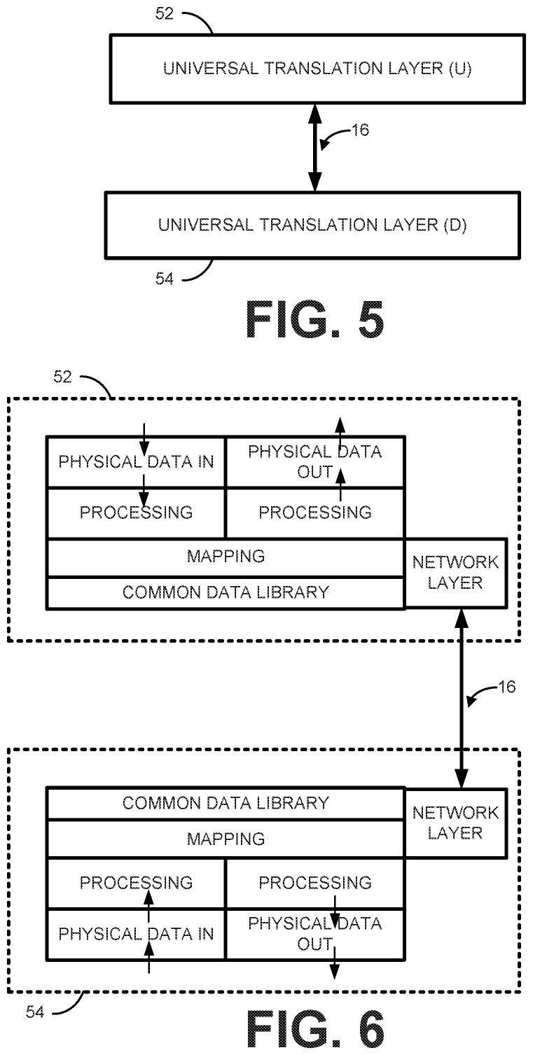

As shown in FIG. 5, the network 16 includes universal translation layers 52 and 54 on the user side (universal translation layer (U) 52) and the device side (universal translation layer (D) 54), each that occur with minimal computational overhead so as to not significantly delay the round trip signal. The universal translation layers 52 and 54 can be with the network 16 and/or with the user 12 and device 14 and may include an application engine, as well as hardware and software layers that transform between user 12 input/output and universal connection data streams, as well as between device 14 input/output and universal connection data streams. Notably, the universal translation layer (U) 52 is able to convert human intent and experience into data stream forms acceptable by a device 14 (and, in some instances, vice versa—by converting a machine output to a form acceptable by the user 12).

The universal translation layers 52 and 54 are shown in greater detail in FIG. 6. As illustrated, each universal translation layer 52 and 54 has a mapping layer, a common data library, and a network layer. In this example, each universal translation layer 52 and 54 is specific for the user (e.g., can be specific for iSens or other data collection/delivery mechanism) or type of device. However, the network 16 may have only a single universal translation layer that includes one or more of each of the mapping layer, the common data library, and the network layer. The one or more users 12 and the one or more devices 14 can receive different data types and/or formats. The mapping layer and the common data library can encode/decode the different data types and/or formats.

As illustrated, the universal translation layer 52 can receive physiological data from the user 12 (physical data in) and process the physiological data before the processed physiological data is sent to the mapping layer. The mapping layer can encode the physiological data into a format that is acceptable for transfer across the network and/or acceptable by the specific receiving device 14 by consulting the common data library for a translation key. For example, the common data library of the universal translation layer 52 can provide translations between the user 12 and the network 16. The translated physiological data (or “transmissible data”) can be sent through the network layer across the network 16. In some instances, the network layer may add metadata to the translated physiological data.

The universal translation layer 54 can receive the translated physiological data (and any added metadata) at a network layer. The network layer may, in some instances, separate the metadata from the translated physiological data. The translated physiological data is sent to the mapping layer, which can decode the translated physiological data from the form that was sent and encode the translated physiological data to the form that is acceptable by the specific receiving device 14 by consulting the common data library for another translation key. For example, the common data library of the universal translation layer 54 can provide translations between the network 16 and the device 14. This retranslated physiological data (in the language acceptable by the device 14) can be processed and sent to the device 14 (physical data out). In response, the device 14 can send the feedback signal to the universal translation layer 54 (physical data in), which can process the signal. The feedback signal can be sent to the mapping layer, which can encode the feedback signal to the format that is acceptable for transfer across the network and/or acceptable by the specific user 12 by consulting the common data library for yet another translation key. For example, the common data library of the universal translation layer 54 can provide translations between the device 14 and the network 16. The translated feedback signal (can also be referred to as “transmissible data”) can be sent through the network layer across the network 16. In some instances, the network layer may add metadata to the translated physiological data.

The universal translation layer 52 can receive the translated feedback signal (and any added metadata) at a network layer. The network layer may, in some instances, can separate the metadata from the translated feedback signal. The translated feedback signal is sent to the mapping layer, which can decode the translated feedback signal and encode the feedback signal to the form that is acceptable by the specific receiving user 12 by consulting the common data library for an appropriate translation key. For example, the common data library of the universal translation layer 52 can provide translations between the network 16 and the user 12. This retranslated feedback signal (in the language acceptable by the user 12, or a “user-transmissible feedback signal”) can be processed and sent to the user 12 (physical data out). The user-transmissible feedback signal can, for example, provide sensory feedback to the user 12 based on the physiological data providing the instruction.

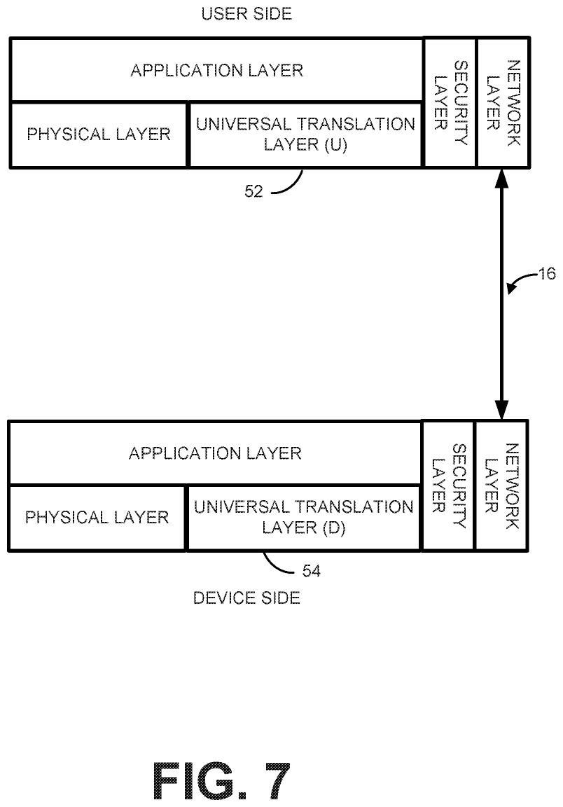

FIG. 7 shows additional components that may accompany the universal translation layers 52 (on the user-side) and 54 (on the device-side) to facilitate communication between a user 12 and a device 14. For example, both the user side and the device side have one or more of a physical layer (that enables data collection), an application layer, a security layer, and a network layer, in addition to the universal translation layer 52 or 54. It will be understood that the user side and/or the device side can include different layers and that FIG. 7 merely shows an example implementation.

### IV. Methods

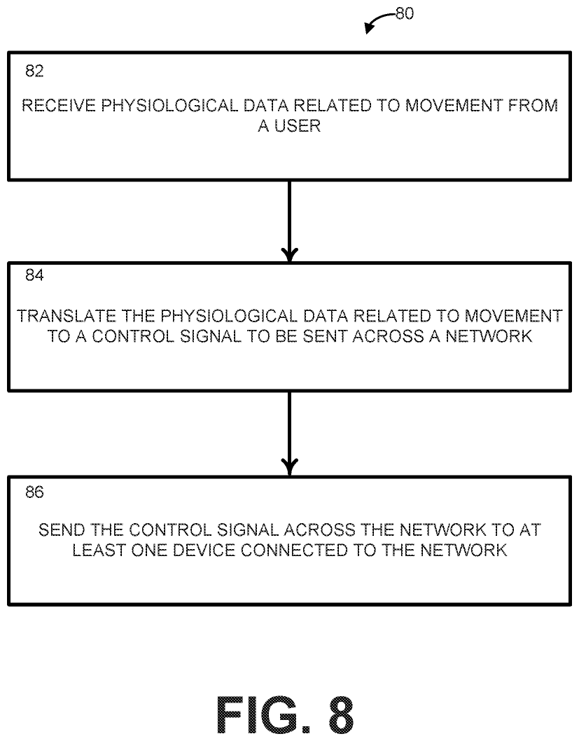

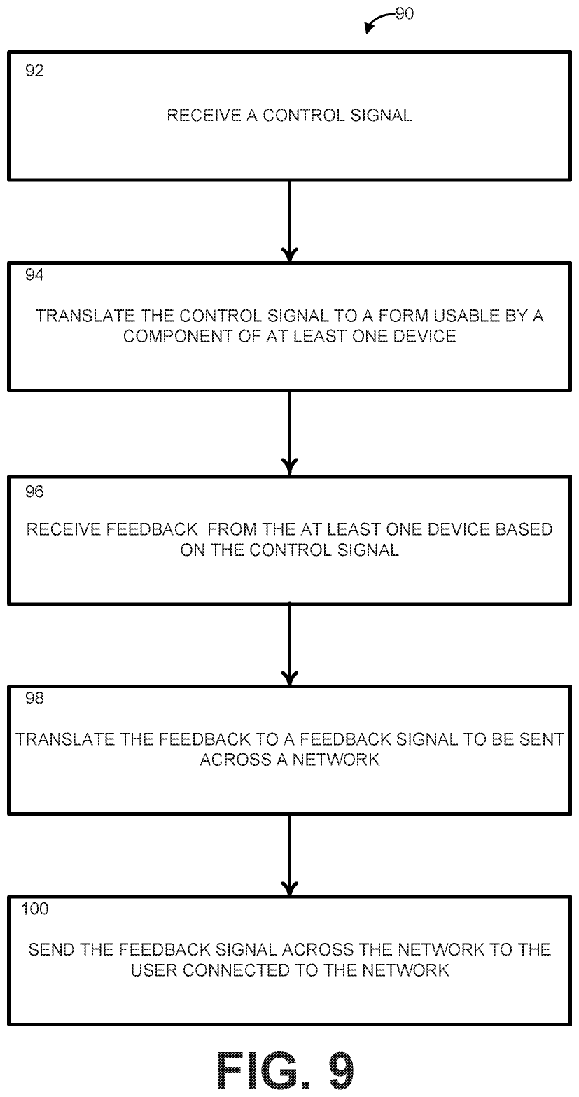

Another aspect of the present disclosure can include methods 80 and 90 for achieving human-machine integration to facilitate Human Fusions by providing reliable endpoint-to-endpoint connection and communication between one or more humans and one or more devices, as shown in FIGS. 8 and 9. The methods 80 and 90 can be executed using the systems 10, 20, 30, or 40 shown in FIGS. 1-4, using the translation hardware and software of FIGS. 5-7, for example. The methods 80 and 90 can allow the user to control a remote device, while receiving sensory feedback related to the control, enabling the user's brain and entire nervous system to transcend the barriers of the user's body and cross the distance separating the user and the device. The network 16 provides a universal connection between user(s) and device(s) so that the user(s) and device(s) can each send outputs and receive inputs across a common network structure that is endpoint-agnostic. It should be noted that the user(s) and device(s) can be referred to as endpoints, nodes, or the like of the network. Although the terms “user 12” and “device 14” will be used from here forward, it will be understood that “user 12” refers to one or more users and “device 14” refers to one or more devices.

For purposes of simplicity, the methods 80 and 90 are shown and described as being executed serially; however, it is to be understood and appreciated that the present disclosure is not limited by the illustrated order as some steps could occur in different orders and/or concurrently with other steps shown and described herein. Moreover, not all illustrated aspects may be required to implement the methods 80 and 90 and/or more than the illustrated aspects may be required to implement the methods 80 and 90. Additionally, one or more aspects of the methods 80 and 90 can be stored in one or more non-transitory memory devices and executed by one or more hardware processors.

Referring now to FIG. 8, illustrated is an example of a method 80 for transmitting physiological data from a user (e.g., user 12) across a network (e.g., network 16) as a control signal. As an example, the user can be a human and the physiological data can be, for example, data (e.g., data associated with a muscle, data associated with a nerve, etc.) recorded by one or more electrodes (e.g., surface electrodes, implanted electrodes, etc.), data gathered by an input device (e.g., a button press, a keystroke, an audio signal, or the like). As an example, the user can be equipped with a HAPTIX iSens system that can be connected to the network to provide the physiological signal, and also to receive a feedback signal.

At Step 82, physiological data related to movement can be received (e.g., by universal translation layer (U) 52) from a user (e.g., user 12). At Step 84, the physiological data related to movement can be translated to a control signal (e.g., by universal translation layer (U) 52 using a common data library). The control signal can be configured for transmission across the network. At Step 86, the control signal can be sent across the network to at least one device (e.g., device 14) connected to the network (e.g., network 16).

Referring now to FIG. 9, illustrated is an example of a method 90 for receiving a control signal and sending a feedback signal (e.g., from device 14 in response to receiving the control signal and/or taking an action based on the control signal) across the network (e.g., network 16).

At Step 92, the control signal can be received (e.g., by universal translation layer (D)). The control signal can be configured for transmission across the network. At Step 94, the control signal can be translated (e.g., by universal translation layer (D)) to a form usable by at least a component of the device (e.g., device 14). The control signal in the form usable by at least the component of the device (e.g., a controller/microcontroller/processor associated with the device) can be sent to the at least the component of the device. The device can perform an action based on the control signal.

At Step 96, feedback can be received (e.g., by universal translation layer (D)) from the device (e.g., the same or different components of device 14) based on the control signal. At Step 98, the feedback can be translated (e.g., by universal translation layer (D)) to a feedback signal to be sent across a network (e.g., network 16 to a component associated with user 12). At Step 100, the feedback signal can be sent across the network (e.g., network 16) to the user (e.g., a component associated with user 12) connected to the network. The feedback signal after conversion can be a neural input that can provide sensory feedback to the user (e.g., delivered by one or more electrodes).

As shown in FIGS. 8 and 9, the communication between the user and the device can include a motor output from the user that is transmitted to the device across the network instructing the device to perform an action, while the device can send a feedback signal to the user, which can receive a sensory input. The device or component of the device can perform a military action, a healthcare action, a gaming action, an entertainment action, and/or a social action, for example.

### V. Examples

The potential applications for Human Fusions are almost limitless. The following non-limiting examples show several potential applications for Human Fusions made possible by the systems and methods of the present disclosure, including medical applications, public safety/defense applications, industrial applications, and social/entertainment/gaming applications. For example, physiological data from a user 12 can be input to control a medical action, a public safety/defense action (e.g., related to military, police, or the like), an industrial action, and/or a social/entertainment/gaming action. The user 12 can receive sensory feedback from a device associated with the medical action, the public safety/defense action (e.g., related to military, police, or the like), the industrial action, and/or the social/entertainment/gaming action. The device can facilitate performance of the medical action, the public safety/defense action (e.g., related to military, police, or the like), the industrial action, and/or the social/entertainment/gaming action. The following examples are for the purpose of illustration only are not intended to limit the scope of the appended claims.

Medical Applications

Much of the Human Fusions technology has sprung from research regarding mechanical devices for patients with an amputated limb. One such mechanical device is a prosthetic device that mechanically replaces the missing limb, but also enables patients to grasp, manipulate, and feel objects as though the limb were not missing. While researching this prosthetic device, it was discovered that the prosthetic device need not even be attached to the patient for the patient to feel the object. The prosthetic device not needing to be attached to the patient has led to the concept of Human Fusions applied to a wider range of medical applications, which has become possible using the systems and methods for human-machine integration that providing reliable endpoint-to-endpoint connection and communication between humans (e.g., a clinician) and one or more remote devices (e.g., medical tools associated with a patient, which may be at a remote location) of the present disclosure. The systems and method of the present disclosure can revolutionize the practice of medicine at least by enabling healthcare practitioners treat formerly isolated populations and improving the safety and efficacy of many medical procedures, both invasive and non-invasive.

Human Fusions can embody remote medicine. For example, using the systems and methods of the present disclosure, physical examinations would no longer be limited to face-to-face interactions between a patient and clinician. Instead, the patient and clinician may be located anywhere in the world, removing space, time, and monetary barriers to healthcare.

Human Fusions technology can greatly expand the amount of information clinicians can collect while conducting otherwise routine examinations. A clinician may be able to better interpret and diagnose a patient using the sense of touch rather than, or in addition to, vision alone. For example, an OB/Gyn can use Human Fusions to “feel” a fetus' heartbeat while performing an in-utero exam, or to “feel” ultrasound information indicating an irregular tissue mass in the breast. As another example, a surgeon engaging in robotic surgery could use Human Fusions to heighten tactile senses to help identify specific anatomical structures which are difficult to detect visually.

Public Safety/Defense Applications

Human Fusions also presents an opportunity for police, military, and other public safety/defense organizations. Individual members of such police, military, and other public safety/defense organizations are highly trained, yet subject to danger on a daily basis. These individuals' lives can be improved by using the systems and methods of the present disclosure, forging a symbiotic relationship between an individual and a robotic device that can allow highly trained individuals to conduct their work with more precision from a safe distance, ultimately preventing injuries that result in amputation and other morbidities/mortalities.

One of the most dangerous jobs in the military is that of an Explosive Ordnance Disposal specialist. The systems and methods of the present disclosure can allow the Explosive Ordnance Disposal specialist to use a device to disarm and dispose of the explosive ordnance without being in the same location, but experiencing the sensations similarly to performing the work on site. This can eliminate the danger of a single mistake potentially maiming or killing the Explosive Ordnance Disposal specialist, but also avoiding the risks of working in a hostile environment and being shot at while doing their job.

A pilot can feel what is happening in, or to, their aircraft with much greater detail using robotic control based on the systems and methods of the present disclosure. Feedback from a robotics system (e.g., a drone pilot, a robotic aircraft, or the like) can be returned to the pilot to improve control and operation of the craft.

### INDUSTRIAL APPLICATIONS

Human Fusions could impact humanity's experience of physical reality, especially in connection with industry. By fusing human consciousness with robots and other technology using the systems and methods of the present disclosure, the human is physically removed from conditions too dangerous or difficult to reach but still perceives and functions as though at the location of the robot.

Using the systems and methods of the present disclosure, manufacturing and other commercial objectives could be made safer, cheaper and easier to reach by allowing personnel to interact with materials remotely, without losing the level of dexterity or sensory input normally gained through direct physical interaction. A carpenter can use conventional carpentry tools, but can receive a sensation of fingers scanning over a wall to feel a stud or wire. A mechanic can diagnose engine performance by “feeling” vibrations or temperature information from sensors inside an engine. In a further example, an assembly worker can bend and manipulate iron with the strength and precision of machinery. In short, Human Fusions can democratize the advantages of manufacturing systems, giving super-human power to a wider variety of workers in a vast array of industries.

Social/Entertainment/Gaming Applications

Human fusions could also enhance humanity's experience of physical reality, especially in connection with social, entertainment, and/or gaming applications. Using the systems and methods of the present disclosure, sensation can be added to various social, entertainment, and/or gaming applications. The communicative power of media rests in the ability to make one feel an experience through sight, sound, and interaction. Adding a sensory experience to video or audio data (other than vision and/or hearing) may be able to enhance the experience so that the experience becomes more powerful. Social media can be augmented by allowing virtual contact between persons, such as allowing one person to perceive the sensation of holding another person's hand. The sensory experience can also involve virtual contact for gaming applications, adding depth and a sense of realism.

From the above description, those skilled in the art will perceive improvements, changes and modifications. Such improvements, changes and modifications are within the skill of one in the art and are intended to be covered by the appended claims.

The following is claimed:

1. A method comprising:
receiving, by a controller comprising a processor, physiological data related to movement from a user;
translating, by the controller, the physiological data related to movement to a transmissible signal to be sent across a network; and
sending, by the controller, the transmissible signal across the network to at least one device connected to the network,
wherein the at least one device translates at least a portion of the transmissible signal to a form usable by a component of the at least one device to perform an action based on the physiological data related to movement.

2. The method of claim 1, wherein the at least one device sends a feedback signal through the network to the controller, further comprising;
translating, by the controller, at least a portion of the feedback signal to a user-transmissible feedback signal; and
sending, by the controller, the user-transmissible feedback signal to the user.

3. The method of claim 2, wherein the user-transmissible feedback signal is sent to the user in to be delivered as a neural input.

4. The method of claim 3, wherein the user-transmissible feedback signal provides a sensory input to the user.

5. The method of claim 1, wherein the controller comprises a universal translation layer to facilitate the translating from the physiological data related to movement to the transmissible signal.

6. The method of claim 5, wherein the at least one device comprise the universal translation layer to facilitate the translating from the transmissible signal to the form usable by the component of the at least one device.

7. The method of claim 6, wherein the universal translation layer comprises a common data library.

8. The method of claim 1, wherein the component of the at least one device performs a military action, a healthcare action, a gaming action, an entertainment action, and/or a social action.

9. The method of claim 1, wherein receiving further comprises receiving the physiological data related to movement generated by a nerve and/or a muscle of the user from at least one surface electrode or implanted electrode associated with the nerve and/or the muscle.

10. A system comprising:
at least one electrode configured to record a physiological data related to movement from a nerve and/or a muscle of a user;
a controller, coupled to the at least one electrode and connected to a network, comprising a processor configured to;
receive the physiological data related to movement;
translate the physiological data related to movement to a transmissible signal; and
send the transmissible signal across the network to at least one device connected to the network,
wherein the at least one device translates at least a portion of the transmissible signal to a form usable by a component of the at least one device to perform an action based on the physiological data related to movement.

11. The system of claim 10, wherein at least two devices are connected to the network to receive the transmissible signal and each of the at least two devices translates the at least the portion of the transmissible signal to a form usable by at least two components of the at least two devices to perform an action based on the physiological data related to movement.

12. The system of claim 11, wherein the at least two devices translate the at least the portion of the transmitted signal to different forms usable by the at least two components of the at least two devices.

13. The system of claim 10, wherein the at least one device sends a feedback signal through the network to the controller, wherein the processor is further configured to:
translate at least a portion of the feedback signal to a user-transmissible feedback signal; and
send the user-transmissible feedback signal to the at least one electrode.

14. The system of claim 13, wherein the user-transmissible feedback signal provides sensory feedback to the user.

15. The system of claim 10, wherein the processor executes a universal translation layer to facilitate the translating from the physiological data related to movement to the transmissible signal.

16. The system of claim 15, wherein the at least one device comprise the universal translation layer to facilitate the translating from the transmissible signal to the form usable by the component of the at least one device.

17. The system of claim 16, wherein the universal translation layer comprises a common data library.

18. The system of claim 10, wherein the component of the at least one device performs at least one of a military action, a healthcare action, a gaming action, an entertainment action, and a social action.

19. The system of claim 10, wherein the physiological data related to movement is intended to control at least a portion of the at least one of the military action, the healthcare action, the gaming action, the entertainment action, and the social action.

20. The system of claim 10, wherein the physiological data related to movement is generated by a nerve and/or a muscle of the user and the at least one electrode comprises at least one surface electrode or implanted electrode associated with the nerve and/or the muscle.
